(19) United States
(12) Patent Application Publication
(10) Pub. No.: US 2004/0211534 A1
(43) Pub. Date: Oct. 28, 2004

(54) Creping additives for paper webs

(76) Inventors: Nancy S. Clungeon, Manawa, WI (US); Bruce J. Kokko, Neenah, WI (US); David W. White, Clintonville, WI (US); Jeffery J. Boettcher, Appleton, WI (US)

Correspondence Address: DILWORTH & BARRESE, LLP, 333 EARLE OVINGTON BLVD., UNIONDALE, NY, 11553, US

(21) Appl. No.: 10/422,328

(22) Filed: Apr. 24, 2003

(51) Int. Cl. B31F 1/12; D21H 17/00

(52) U.S. Cl. 162/111; 162/164.6; 162/158; 162/181.2; 162/179; 264/283

(57) ABSTRACT

A method for creping a paper web includes applying, separately or together, to a surface of a rotatable creping cylinder, a creping adhesive and at least one creping adhesive modifier which is a polyoxyalkylene resin possessing repeating oxyalkylene groups containing at least 3 carbon atoms. The method further includes the steps of adhering a paper web to the surface of the creping cylinder and removing the paper web from the creping cylinder with a doctor blade to provide a creped paper product.

### BACKGROUND

1. Technical Field

The present disclosure relates generally to the field of creping methods for paper tissue and towels, and more particularly to adhesive additives to facilitate the creping of paper webs for making disposable paper tissue and towels.

2. Background of the Art

Creping is a means of mechanically compacting paper in the machine direction. The result is an increase in basis weight (mass per unit area) as well as dramatic changes in many physical properties, particularly when measured in the machine direction. Creping is generally accomplished with a flexible blade, a so-called doctor blade, against a Yankee dryer in an on-machine operation. This blade is also sometimes referred to as a creping blade or simply a creper.

Paper is generally manufactured by suspending cellulosic fiber of appropriate geometric dimensions in an aqueous medium and then removing most of the liquid. The absorbent paper product of the present invention can be manufactured on any type papermaking machine. Traditionally, the production of absorbent paper occurs by one of three basic technologies: (i) conventional wet press technology with wet creping and embossing, as described in U.S. Pat. No. 5,048,589 to Cook et al. which is incorporated herein by reference in its entirety; (ii) conventional wet press technology with dry creping and embossing, as described in U.S. Pat. No. 5,048,589; and most recently (iii) through-air-drying (TAD) with or without creping. Conventional TAD processes are generally described in U.S. Pat. Nos. 3,301,746 to Sanford et al. and U.S. Pat. No. 3,905,863 to Ayers, which are incorporated herein by reference in their entirety.

A Yankee dryer is a large diameter, generally 8-20 foot drum which is designed to be pressurized with steam to provide a hot surface for completing the drying of papermaking webs at the end of the papermaking process. The paper web which is first formed on a formations forming carrier, such as a Fourdrinier wire, where it is freed of the copious water needed to disperse the fibrous slurry is usually transferred to a felt or fabric in a so-called press section where de-watering is continued either by mechanically compacting the paper or by some other de-watering method such as through-drying with hot air, before finally being transferred in the semi-dry condition to the surface of the Yankee for the drying to be completed.

The impact of the adhered web with the doctor blade is essential to impart to the paper web the properties which are sought by manufacturers. Of particular importance are softness, strength and bulk.

Softness is the tactile sensation perceived by the consumer as he/she holds a particular product, rubs it across his/her skin, or crumples it within his/her hand. This tactile sensation is provided by a combination of several physical properties. One of the most important physical properties related to softness is generally considered by those skilled in the art to be the stiffness of the paper web from which the product is made. Stiffness, in turn, is usually considered to be directly dependent on the strength of the web.

Bulk, as used herein, refers to the inverse of the density of a tissue paper web. It is another important part of real and perceived performance of tissue paper webs. Enhancements in bulk generally add to the cloth like, absorbent perception. A portion of the bulk of a tissue paper web is imparted by creping.

Referring to the drawing FIG. 1, this represents one of a number of possible configurations used in processing tissue products. In this particular arrangement, the transfer and impression fabric designated as 1 carries the formed, dewatered web 2 around turning roll 3 to the nip between press roll 4 and Yankee dryer 5. The fabric, web and dryer move in the directions indicated by the arrows. The entry of the web to the dryer is well around the roll from creping blade 6 which, as schematically indicated, crepes the traveling web from the dryer as indicated at 7. The creped web 7 exiting from the dryer is wound into a soft creped tissue roll 8. To adhere the nascent web 2 to the surface of the Yankee dryer, a spray 9 of adhesive is applied to the surface ahead of the nip between the press roll 4 and Yankee 5. Alternately, the spray may be applied to the traveling web 2 directly as shown at 9′. Suitable apparatus for use with the present invention as disclosed in U.S. Pat. Nos. 4,304,625 and 4,064,213, which are hereby incorporated by reference.

The level of adhesion of the papermaking web to the dryer is also of vital importance as it relates to the contact of the web to the dryer, the control of the web in its travel in the space between the creping blade and the winder, the drying of the web and crepe formation. In addition, different creped products require different levels of adhesion, tack and rewetability, for example a facial tissue web will require a different level of adhesion, tack and rewetability compared to a paper towel web. Webs which are insufficiently adhered tend to cause poor control of the sheet with consequent difficulties in forming a uniform reel of paper. A loose sheet between the creper and the reel will result in wrinkles, foldovers, or weaving of the edges of the sheet in the rolled-up paper. Poorly formed rolls not only affect the reliability of the papermaking operation, but also the subsequent operations of tissue and towel manufacture in which the rolls are converted into the tissue and towel products.

The level of adhesion of the papermaking web to the dryer is also of vital importance as it relates to the drying of the web. Higher levels of adhesion reduce the impedance of heat transfer and cause the web to dry faster, enabling more energy efficient, higher speed operation. Low levels of adhesion can cause insufficient heat transfer and poor drying of the web.

However, the level of adhesion is not the sole factor determining product quality and manufacturing reliability since too much adhesion can cause the web to not dislodge properly so that portions of the web remain adhered to the dryer and travel past the edge of the blade. This causes a defect in the web and often causes the web to break.

Further, while some amount of build-up of the adhesive on the dryer is essential, excessive build-up or streaks can be formed with some types of adhesives. Streaks can cause differences in the profile of adhesion across the width of the dryer. This can result in humps or wrinkles in the finished roll of paper. Referring again to FIG. 1, a second doctor blade 6′ is often positioned after the creping blade 6 in order to remove any excess creping adhesive and other residue left behind. Blade 6′ is referred to as a cleaning blade. Cleaning blades and creping blades must be changed at some frequency to prevent a streaky coating and loss of sheet control.

The term “doctorability” as used herein refers to the relative ease with which the web is dislodged from the dryer without producing defects or requiring frequent changes of blades to prevent excessive build-up.

Another important characteristic of a creping adhesive is that it be rewetable. “Rewetability”, as used herein, refers to the ability of the adhesive film remaining on the heated drying surface after the creping/cleaning blades to be activated by the moisture contained in the semi-dry issue web when the web is brought into contact with the heated drying surface. A marked increase in tack is indicative of high rewetability.

Rewetability is important because only a portion of the drying surface is normally covered with adhesive on a given rotation of the Yankee dryer. The majority of the adhesion of the sheet to the dryer occurs by means of the creping adhesive deposited in previous passes.

There is a natural tendency of the paper making web to adhere to the cylindrical dryer owing to the build-up of deposits of both organic and inorganic components from the paper web. These components (fines, fillers and papermaking chemical additives) can form deposits that can impact the creping process efficiency at the point of transfer of the web to the cylindrical drum. The needs for specific level and type of adhesion however has induced considerable activity among researchers in the field. Consequently, a wide variety of creping adhesives are known in the art. The use of animal glue, hemicellulose, PAE resins and polyvinyl alcohol have long been known.

Various other creping additives are known. For example, polyaminoamide-epichlorohydrin (“PAE”) compounds have been used and typically form a hard coating with poor rewetability properties.

Addition of polyethylene glycol (“PEG”) and polyethylene glycol esters to creping adhesive products can be used to help soften and/or plasticize the creping adhesive coating. However, this may not always be effective since the PEG and PEG esters are not very substantive, i.e., such esters are not well retained. Alternatively, softeners such as quaternary amine softeners may be added to the coating formulation to modify or soften the creping adhesive coating. However, use of the quaternary amine softeners often involves the need for additional creping adhesive equipment or product formulation costs in order to add this component to the system.

Improvements include use of metal ions to form a non-self crosslinking adhesive coating as described in U.S. Pat. No. 6,336,995, which is herein incorporated by reference, discloses an adhesive for applying to a creping surface.

The adhesive includes a water-soluble, thermosetting, cross-linked polyamide-epihalohydrin resin complexed with metal ions.

However, what is needed is a new and improved system of chemical additives for use as or with the above mentioned creping adhesives to impart enhanced adhesive, rewetability and/or lubricating properties.

### SUMMARY OF THE INVENTION

A method for creping a paper web is provided herein. The method comprises: (a) applying, separately or together, to a surface of a rotatable creping cylinder, a creping adhesive and at least one creping adhesive modifier which is a polyoxyalkylene polymer possessing oxyalkylene groups containing at least 3 carbon atoms; (b) adhering a paper web to the surface of the creping cylinder; and, (c) removing the paper web from the creping cylinder with a doctor blade to provide a creped paper product. The doctor blade may be straight edged or grooved, made from steel, steel alloys, ceramic or other material.

The creping adhesive composition described herein provides an enhanced combination of rewetability, dry tack and wet tack for improved creping performance.

### BRIEF DESCRIPTION OF THE DRAWINGS

Various embodiments are described herein with reference to the drawings wherein:

FIG. 1 is an illustration of known paper creping process and equipment.

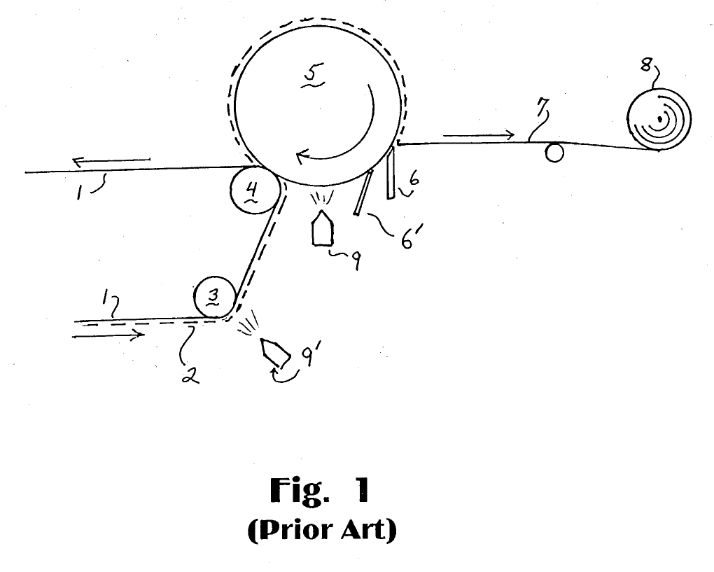

### DETAILED DESCRIPTION OF PREFERRED EMBODIMENT(S)

The adhesive composition of the present invention includes a creping adhesive and a creping adhesive modifier to improve softness, rewetability and lubricity.

The creping adhesive is optionally a cationic resin having azetidinium or epoxide functionality. Such resins include polymeric amine-epichlorohydrin resins, such as polyamidoamine-epichlorohydrin (PAE) resin, poly(diallylamine)-epichlorohydrin resin, polyalkylene polyamine-epichlorohydrin resin (PAPAE), polyamidoamine-epichlorohydrin resin (PAAE). Quaternary ammonium epoxide resins are also useful. Other useful adhesives include the reaction product of an epihalohydrin and an end-capped polyaminamide polymer as described in U.S. Pat. No. 6,222,006 (which is herein incorporated by reference), a polyamidoamine-epichlorohydrin resin bearing polyol side chains as described in U.S. Pat. No. 6,165,322 (which is herein incorporated by reference), water soluble polyalkanolamides as disclosed in U.S. Pat. No. 6,133,405 (which is herein incorporated by reference), complexes of hydrophobically modified polyaminamide and a non-ionic surfactant as disclosed in U.S. patent application Ser. No. 09/852,997 filed May 10, 2001 (which is herein incorporated by reference), and the reaction product of polyamide and polyvinyl alcohol as described in PCT publication WO 00/39396 (which is herein incorporated by reference).

A particularly suitable creping adhesive is a wet strength agent such as PAE, which contains cationic sites which form ionic bonds with the carboxyl sites on the pulp fibers. PAE polymer suitable for use as a creping adhesive is commercially available under the designation Unicrepe C-77® and Unicrepe 920® from Georgia Pacific Corp. of Atlanta, Ga., and Crepecel 690HA® from Ondeo-Nalco of Naperville, Ill.

Other suitable creping adhesives include, for example, hydrophobically modified PAE, polyvinyl acetate-ethylene copolymer, and polyvinyl alcohol (PVOH). A PVOH resin suitable for use as a creping adhesive is available under the designation Celvol 523®, Celvol 540®, and Celvol 205® from Celanese Corp. of Dallas, Tex. The hydrophobically modified PAE resin can be prepared by reacting a PAE resin with an anionic polyelectrolyte such as that made by reacting a polymeric compound having anhydride groups with a secondary amine having at least one fatty aliphatic group.

The creping adhesive modifier can be any polyoxyalkylene homopolymer or copolymer possessing at least some oxyalkylene groups containing at least 3 carbon atoms. However, the preferred creping adhesive modifier is a multifunctional polymer having at least one partially hydrophilic group and at least one partially hydrophobic (lipophilic) group. More particularly, the preferred multifunctional polymer is a polyoxyalkylene ether or ester derivative thereof having the formula:

[R⁵O(—R⁴O)ₘ—]ₚR^{1(—OR}²—)_{n(—OR}³) (I)

wherein R¹ is a saturated or unsaturated, straight or branched chain hydrophobic aliphatic group containing from about 8 to about 36 carbon atoms, preferably from about 10 to about 24 carbon atoms, and more preferably from about 12 to about 20 carbon atoms; R² and R⁴ each independently is an alkylene group or a mixture of different alkylene groups containing from 2 to 4 carbon atoms, provided that an average of at least about 25% percent of the alkylene groups contain at least 3 carbon atoms; R³ and R⁵ each independently is hydrogen or the same or different acyl group —C(O)R⁶ wherein R⁶ is a methyl, ethyl or hydroxyethyl group; m is an integer from 2 to about 20, n an integer of from 2 to about 20, and the sum of m+n is an integer of from 2 to about 20, and p is 0 or 1.

Compounds of formula I can be made by reacting an aliphatic alcohol R¹OH or aliphatic diol HOR¹OH with one or more alkylene oxide(s) (e.g., propylene oxide) in accordance with methods known in the art. When p in the polyoxyalkylene resin of formula I is 0, R¹ is an aliphatic residue of a monoalcohol R¹OH. For a polyoxyalkylene resin in which p is 1, R¹ is the aliphatic residue of a diol HOR¹OH such as, for example, a dimer fatty alcohol such as any of those described in U.S. Pat. Nos. 2,347,562, 3,091,600, 5,545,692 and 5,621,065, the contents of which are incorporated by reference herein. It is therefore to be understood that the term “aliphatic” as it applies to R¹ contemplates aliphatic cyclic moieties as well as linear and branched open chain moieties.

Ester compounds, wherein R³ and/or R⁵ is —C(O)R⁶, can be made, e.g., by reacting a terminal OH group of the formula I compound (i.e., wherein R³ and/or R⁵ is hydrogen) with a desired carboxylic acid R⁶COOH, methyl ester, or corresponding acid halide, in accordance with procedures known in the art.

A preferred polyoxyalkylene compound for use as the multifunctional polymer is a polyoxypropylene ether of a saturated fatty alcohol having the formula:

CH₃(CH₂)ₛ[—OCH(CH₃)CH₂—]ₙ—OH

wherein n is from about 8 to about 16 and s is from about 10 to about 24. Especially preferred is a polyoxypropylene ether of stearyl alcohol admix with propylene glycol wherein s is 17 and n is 11, and which is commercially available under the designation Varonics APS from Goldschmidt Chemical Corporation of Hopewell, Va., or which is also available from ChemTreat Inc. of Glen Allen Va. as Softener CS 359. Also particularly preferred are polypropylene glycol (PPG) stearyl ethers, wherein the polyproylene glycol has a degree of polymerization of 10 to 11.

Other suitable oxypropylene based esters and/or ethers would include PPG esters and/or ethers of oleic, stearic, lauric, or other fatty acid chains, saturated or unsaturated, branched, straight chain or alicyclic. Other suitable multifunctional polymers may include, but are not limited to, esters, ethers, or molecules that are the reaction product of pentaerythritol, 1,6-hexanediol, glycerol, or any other diol or polyol.

The creping composition can further include polyols such as glycerol, propylene glycol, ethylene glycol, polyethylene glycol, alkyl polyglucoside and the like, which can serve multiple purposes as surfactants and/or co-solvents and/or viscosity reducers. Moreover, the creping composite can include one or more inorganic salt such as ammonium zirconium carbonate, potassium zirconium carbonate, or any phosphate salt.

Features and advantages of the invention are illustrated by the following Examples. Compositions outside of the scope of the invention are set forth in the Comparative Examples below. All percentages are by weight unless indicated otherwise.

### EXAMPLE 1

A creping composition in accordance with the invention was prepared by combining the following components to form a liquid solution:

| | |
|---|---|
| Creping Adhesive (95%): | PVOH (Celvol 205 ®) |
| Creping adhesive modifier (5%): | PPG 596 stearyl ether |
| | (Varonics APS ®) |

The liquid composition was applied to a test surface and allowed to dry to form a film. The film was tested for flexibility, dry tack, wet tack and rewetability. The test method and evaluation procedures are as follows:

Solutions were prepared in 20 ml glass vials and mixed for 30 seconds on a vortex mixer (VWR Scientific Products: Standard Mini Vortexer). The ratios of the components are based on percent of the total solution solids. Films were formed by weighing an aliquot of each solution into an aluminum weighing dish (VWR, 50 ML, Cat. No. 25433-010) that will dry to 0.5 gm solids. The solutions were dried for 16 hours in a 105° C. forced air oven. The dishes were removed from the oven and allowed to equilibrate to atmospheric conditions for 5 minutes prior to testing. All percentages are by weight unless indicated otherwise.

Solution stability was determined by observing the formation in the solution of haziness or cloudiness over a one day period. The films were removed from the aluminum dish and visually evaluated for clarity, uniformity, and flexibility.

Flexibility was determined by tactile observation of the ease with which the film could be bent without breaking.

Dry Tack—After the tester removed the oils from the “ball” of his thumb with acetone, the thumb was pressed onto the film surface with a force of ˜15 psi. If the film and dish lifted from the table, the amount of time (measured in seconds) that it took for the film (and dish) to fall from the tester's thumb was recorded.

Wet Tack—A one square inch piece of GP Soft Pull Towel was wetted with tap water and the excess water squeezed out. The wetted towel was pressed into the film with a force of ˜15 psi. If the towel and film stuck together, the dish could be lifted from the table, the amount of time (measured in seconds) that it took for the film to fall from the wet towel was recorded. The longer the towel and film stuck together, the higher the score.

Re-wetability—A drop of tap water was placed on the films. The films were evaluated as to whether they dissolved, swelled, or became “rubbery”.

The results of the tests are set forth in Table 1 below.

### EXAMPLE 2

This example was performed in a manner similar to that of Example 1 except that the following components were used to prepare the liquid creping composition:

| | |
|---|---|
| Creping Adhesive (94%): | PVOH (Celvol 205 ®) |
| Creping adhesive modifier (5%): | PPG 596 stearyl ether |
| | (Varonics APS ®) |
| Other additives (1%): | Ammonium zirconium carbonate |
| | (“Azcote 5800M ®) |

The results of the tests are set forth in Table 1 below.

### EXAMPLE 3

This example was performed in a manner similar to that of Example 1 except that the following components were used to prepare the liquid creping composition:

| | |
|---|---|
| Creping Adhesive (95%): | PAE (Unicrepe C-77 ®) |
| Creping adhesive modifier (5%): | PPG 596 stearyl ether |
| | (Varonics APS ®) |

The results of the tests are set forth in Table 1 below.

### EXAMPLE 4

This example was performed in a manner similar to that of Example 1 except that the following components were used to prepare the liquid creping composition:

| | |
|---|---|
| Creping Adhesive (95%): | PAE (Unicrepe 920 D00) |
| Creping adhesive modifier (5%): | PPG 596 stearyl ether |
| | (Varonics APS ®) |

The results of the tests are set forth in Table 1 below.

### EXAMPLE 5

This example was performed in a manner similar to that of Example 1 except that the following components were used to prepare the liquid creping composition:

| | |
|---|---|
| Creping Adhesive (95%): | PAE (Unicrepe C-77 ®) |
| Creping adhesive modifier (5%): | PPG 596 stearyl ether |
| | (Varonics APS ®) |

The results of the tests are set forth in Table 1 below.

### EXAMPLE 6

This example was performed in a manner similar to that of Example 1 except that the following components were used to prepare the liquid creping composition:

| | |
|---|---|
| Creping Adhesive (95%): | PVOH (ChemTreat 167 ® from |
| | ChemTreat Inc. of Glen Allen VA) |
| Creping adhesive modifier (5%): | PPG 596 stearyl ether |
| | (Varonics APS ®) |

The results of the tests are set forth in Table 1 below.

### EXAMPLE 7

This example was performed in a manner similar to that of Example 1 except that the following components were used to prepare the liquid creping composition:

| | |
|---|---|
| Creping Adhesive (95%): | PVOH (Celvol 540 ®) |
| Creping adhesive modifier (5%): | PPG 596 stearyl ether |
| | (Varonics APS ®) |

The results of the tests are set forth in Table 1 below.

### EXAMPLE 8

This example was performed in a manner similar to that of Example 1 except that the following components were used to prepare the liquid creping composition:

| | |
|---|---|
| Creping Adhesive (90%): | PVOH (Celvol 523 ®) |
| Creping adhesive modifier (5%): | PPG 596 stearyl ether |
| | (Varonics APS ®) |
| Other additives (5%): | Zirconium ammonium carbonate |
| | (Azcote 5800M ®) |

The results of the tests are set forth in Table 1 below:

TABLE 1

| | Solution | | Dry | Wet | |
|---|---|---|---|---|---|
| Example | Stability | Film Flexibility | Tack | Tack | Wetability |
| 1 | Cloudy | Slightly | 5 | 5 | Swelled/ |
| | | Flexible | | | dissolved |
| 2 | Cloudy | Slightly | 5 | 5 | Swelled |
| | | Brittle | | | |
| 3 | Hazy | Brittle | 3 | 3 | Swelled |
| 4 | Hazy | Slightly | 2 | 5 | Swelled |
| | | Flexible | | | |
| 5 | Hazy | Brittle | 2 | 3 | Rapid swell |
| 6 | Cloudy | Slightly | 0 | 5 | Slight |
| | | Flexible | | | swelling |
| 7 | Cloudy | Flexible | 0 | 5 | Swelled/ |
| | | | | | dissolved |
| 8 | Very | Clear yellow blisters, | 0 | 5 | Swelled/ |
| | Cloudy | very flexible | | | flexible |

### COMPARATIVE EXAMPLE 1

This comparative example was performed in a manner similar to that of Example 1 except that the following components were used to prepare the liquid creping composition outside of the scope of the invention:

| | |
|---|---|
| Creping Adhesive (100%): | PVOH (Airvol 523 ®, Celanese |
| | Corp., Dallas, Texas) |
| Creping Adhesive Modifier: | None |

The results of the tests are set forth in Table 2 below.

### COMPARATIVE EXAMPLE 2

This comparative example was performed in a manner similar to that of Example 1 except that the following components were used to prepare the liquid creping composition outside of the scope of the invention:

| | |
|---|---|
| Creping Adhesive (95%): | 65% PVOH (Celvol 523 ®) |
| | 35% PAE (Nalco 690 HA ®) |
| Creping Adhesive modifier (5%): | Cationic amine (TQ 2008 ®, |
| | Hercules, Inc., Wilmington, DE) |

The results of the tests are set forth in Table 2 below.

### COMPARATIVE EXAMPLE 3

This comparative example was performed in a manner similar to that of Example 1 except that the following components were used to prepare the liquid creping composition outside of the scope of the invention:

| Creping Adhesive (90%): | PAE (Solvox 4480 ®, Solvox Co., |
|---|---|
| | Milwaukee, WI) |
| Creping Adhesive modifier | Mineral Oil based product (Solvox 5302, |
| (10%): | Solvox Co.) |

The results of the tests are set forth in Table 2 below.

### COMPARATIVE EXAMPLE 4

This comparative example was performed in a manner similar to that of Example 1 except that the following components were used to prepare the liquid creping composition outside of the scope of the invention:

| | |
|---|---|
| Creping Adhesive (93%): | PVOH (Celvol 523 ®) |
| Creping Adhesive modifier (7%): | Potassium polyphosphate |
| | salt (Kalipol 18 ®, Albright & |
| | Wilson, West Midland, UK) |

The results of the tests are set forth in Table 2 below.

### COMPARATIVE EXAMPLE 5

This comparative example was performed in a manner similar to that of Example 1 except that the following components were used to prepare the liquid creping composition outside of the scope of the invention:

| | |
|---|---|
| Creping Adhesive (93%): | PVOH (Celvol 523 ®) |
| Creping Adhesive modifier (7%): | Potassium polyphosphate |
| | salt (Kalipol 18 ®) |

The results of the tests are set forth in Table 2 below.

### COMPARATIVE EXAMPLE 6

This comparative example was performed in a manner similar to that of Example 1 except that the following components were used to prepare the liquid creping composition outside of the scope of the invention:

| | |
|---|---|
| Creping Adhesive (100%): | PAE (Hercules 82-176, Hercules Co. |
| | Wilmington, DE) |
| Creping Adhesive modifier: | None |

The results of the tests are set forth in Table 2 below.

TABLE 2

| Comp. | Solution | Film | Dry | Wet | |
|---|---|---|---|---|---|
| Example | Stability | Flexibility | Tack | Tack | Wetability |
| 1 | Clear | Flexible | 2 | 5 | Slightly |
| | | | | | dissolves |
| 2 | Cloudy | Slightly | 2 | 3 | Flexible/ |
| | | yellow, brittle | | | dissolving |
| 3 | Oil separated | Brown, brittle | 2 | 1 | Slight swelling |
| 4 | Clear | Clear, flexible | 1 | 5 | Slight swelling |
| 5 | Cloudy | Clear, flexible | 1 | 5 | Slight |
| | | | | | swelling |
| 6 | Clear | Brittle | 0 | 3 | Swelled |

As can be seen from the above results, use of PPG stearyl ether achieved very high dry and wet tack and rewetability in Examples 1 and 2 with Celvol 205 PVOH creping adhesive. The PPG stearyl ether displayed very good wet tack and rewetability with PAE creping adhesive in Examples 3, 4, and 5 as shown in Table 1. On the other hand the oil in Comparative Example 3 separated with PAE creping adhesive, the polyphosphate salt in Comparative Examples 4 and 5 did not result in good rewetability. The cationic quaternary amine of Comparative Example 2 produced a brittle film with moderate dry and wet tack.

While the above description contains many specifics, these specifics should not be construed as limitations on the scope of the invention, but merely as exemplifications of preferred embodiments thereof. Those skilled in the art will envision many other possible variations that are within the scope and spirit of the invention as defined by the claims appended hereto.

What is claimed is:

1. A method for creping a paper web comprising:
a) applying, separately or together, to a surface of a rotatable creping cylinder, creping composition which includes a creping adhesive and at least one creping adhesive modifier which is a polyoxyalkylene polymer possessing oxyalkylene groups containing at least 3 carbon atoms;
b) adhering a paper web to the surface of the creping cylinder; and,
c) removing the paper web from the creping cylinder with a doctor blade to provide a creped paper product.

2. The method of claim 1 wherein the creping adhesive is contains at least one substance selected from the group consisting of polyamide-epichlorohydrin resin, poly(diallylamine)-epichlorohydrin resin, polyalkylene polyamine-epichlorohydrin resin, polyamidoamine-epichlorohydrin resin, polyvinyl alcohol, the reaction product of an epihalohydrin and an end-capped polyaminamide polymer, a polyamidoamine-epichlorohydrin resin bearing polyol side chains, complexes of hydrophobically modified polyaminamide and a non-ionic surfactant, water soluble polyalkanolamide, hydrophobically modified polyaminoamide-epichlorohydrin resin, polyvinyl acetate-ethylene copolymer and the reaction product of polyamide and polyvinyl alcohol.

3. The method of claim 1 wherein the creping composition further includes a polyol.

4. The method of claim 3 wherein the polyol is selected from the group consisting of glycerol, ethylene glycol, propylene glycol, polyethylene glycol and alkyl polyglucoside.

5. The method of claim 1 wherein the creping composition further includes an inorganic salt.

6. The method of claim 5 wherein the inorganic salt is selected from the group consisting of phosphate salts, ammonium zirconium carbonate and potassium zirconium carbonate and mixtures thereof.

7. The method of claim 1 wherein the creping adhesive modifier possesses the formula:
[R⁵O(—R⁴O)ₘ—]ₚR¹(—OR²—)ₙ(—OR³)
wherein R¹ is an aliphatic group containing from about 8 to about 36 carbon atoms, R² and R⁴ each independently is an alkylene group or a mixture of different alkylene groups containing from 2 to 4 carbon atoms, provided that an average of at least about 25 percent of the alkylene groups contain at least 3 carbon atoms, R³ and R⁵ each independently is hydrogen or the same or different acyl group —C(O)R⁶ in which R⁶ is a methyl, ethyl or hydroxyethyl group, m is an integer from 2 to about 20, n an integer of from 2 to about 20, and the sum of m+n is an integer of from 2 to about 20, and p is 0 or 1.

8. The method of claim 7 wherein the aliphatic group R¹ contains from about 10 to about 24 carbon atoms.

9. The method of claim 7 wherein the aliphatic group R¹ contains from about 16 to about 20 carbon atoms.

10. The method of claim 7 wherein n is an integer of from about 8 to about 16.

11. The method of claim 7 wherein n is an integer of from 10 to 12.

12. The method of claim 7 wherein R³ is hydrogen and p is 0.

13. The method of claim 7 wherein the creping adhesive modifier is a polyoxypropylene ether of a saturated fatty alcohol of the formula:
CH₃(CH₂)ₛ[—OCH(CH₃)CH₂—]ₙ—OH
wherein n is from about 8 to about 16 and s is from about 10 to about 24.

14. The method of claim 13 wherein n is 10 to 12 and s is from about 16 to about 18.

15. The method of claim 7 wherein the creping adhesive modifier is a saturated or unsaturated, straight chain, branched or alicyclic fatty acid ester of polypropylene glycol.

16. A creping composition which comprises:
a) a creping adhesive; and,
b) a creping adhesive modifier which is a polyoxyalkylene polymer possessing oxyalkylene groups containing at least 3 carbon atoms.

17. The creping composition of claim 16 wherein the creping adhesive is a resin having azetidinium and/or epoxide functionality.

18. The creping composition of claim 16 wherein the creping adhesive is selected from the group consisting of polyamide-epichlorohydrin resin, poly(diallylamine)-epichlorohydrin resin, polyalkylene polyamine-epichlorohydrin resin, polyamidoamine-epichlorohydrin resin, polyvinyl alcohol, the reaction product of an epihalohydrin and an end-capped polyaminamide polymer, a polyamidoamine-epichlorohydrin resin bearing polyol side chains, complexes of hydrophobically modified polyaminamide and a non-ionic surfactant, water soluble polyalkanolamide, hydrophobically modified polyaminoamide-epichlorohydrin resin, polyvinyl acetate-ethylene copolymer and the reaction product of polyamide and polyvinyl alcohol.

19. The creping composition of claim 16 wherein the creping adhesive is a polyvinyl alcohol.

20. The creping composition of claim 16 wherein the creping adhesive modifier has the formula:
[R⁵O(—R⁴O)ₘ—]ₚR¹(—OR²—)ₙ(—OR³)
wherein R¹ is an aliphatic group containing from about 8 to about 36 carbon atoms, R² and R⁴ each independently is an alkylene group or a mixture of different alkylene groups containing from 2 to 4 carbon atoms, provided that an average of at least about 25 percent of the alkylene groups contain at least 3 carbon atoms, R³ and R⁵ each independently is hydrogen or the same or different acyl group —C(O)R⁶ in which R⁶ is methyl, ethyl or hydroxyethyl, m is an integer from 2 to about 20, n an integer of from 2 to about 20, the sum of m+n is an integer of from 2 to about 20, and p is 0 or 1.

21. The creping composition of claim 20 wherein the aliphatic group R¹ contains from about 10 to about 24 carbon atoms.

22. The creping composition of claim 20 wherein the aliphatic group R¹ contains from about 16 to about 20 carbon atoms.

23. The creping composition of claim 20 wherein n is an integer of from about 8 to about 16.

24. The creping composition of claim 20 wherein n is an integer of from 10 to 12.

25. The creping composition of claim 20 wherein R³ is hydrogen and p is 0.

26. The creping composition of claim 20 wherein the creping adhesive modifier is a polyoxypropylene ether of a saturated fatty alcohol of the formula:
CH₃(CH₂)ₛ[—OCH(CH₃)CH₂—]ₙ—OH
wherein n is from about 8 to about 16 and s is from about 10 to about 24.

27. The creping composition of claim 26 wherein n is 10 to 12.

28. The creping composition of claim 16 wherein the creping adhesive modifier is a saturated or unsaturated, straight chain, branched or alicyclic fatty acid ester of polypropylene glycol.
